(19) United States
(12) Patent Application Publication
(10) Pub. No.: US 2019/0211923 A1
(43) Pub. Date: Jul. 11, 2019

(54) SHIFT DEVICE

(71) Applicant: KABUSHIKI KAISHA TOKAI-RIKA-DENKI-SEISAKUSHO, Aichi-ken (JP)

(72) Inventors: Munetoshi MAKIMURA, Aichi-ken (JP); Kunihiro MORIMURA, Plymouth, MI (US)

(21) Appl. No.: 15/862,654

(22) Filed: Jan. 5, 2018

(51) Int. Cl. F16H 61/32; F16H 59/10; F16H 61/24; F16H 59/02; F16H 61/28

(52) U.S. Cl. CPC F16H 61/32; F16H 59/10; F16H 61/24; F16H 2059/0247; F16H 2059/0282; F16H 2061/2892; F16H 2061/326; F16H 59/0278

(57) ABSTRACT

In a shift lever device, a drive motor is driven such that a second worm wheel is rotated in order to pivot a shift lever toward a P position side. When a detection device has detected that the shift lever is about to be pivoted to the P position, a stopper mechanism is actuated such that a link is moved. When the shift lever has been pivoted to the P position, the link is fitted into a stopper notch in the second worm wheel, thereby stopping rotation of the second worm wheel. This thereby enables the shift lever to be stopped appropriately at the P position.

### BACKGROUND

### Technical Field

The present invention relates to a shift device in which a shift body is moved to change a shift position of the shift body.

### Related Art

Japanese Patent Application Laid-Open (JP-A) No. 2014-156153 describes a shift lever device in which a drive mechanism is actuated to move a shift lever to a P position.

In this shift lever device, it is preferable that the shift lever can be made to stop appropriately at the P position when the drive mechanism is actuated.

### SUMMARY

In consideration of the above circumstances, an object of the present invention is to obtain a shift device capable of stopping a shift body appropriately at a predetermined shift position when a mover device moves the shift body.

A shift device of a first aspect of the present invention comprises: a shift body that is moved to change a shift position; a mover device that moves the shift body to a predetermined shift position; a detection device that detects a movement position of the shift body; and a stopper mechanism that stops the shift body at the predetermined shift position based on the movement position of the shift body detected by the detection device when the mover device has moved the shift body.

In the shift device of the first aspect of the present invention, the shift body is moved so as to change the shift position of the shift body. Moreover, the mover device moves the shift body to the predetermined shift position. The detection device detects the movement position of the shift body.

When the mover device has moved the shift body, the stop mechanism stops the shift body at the predetermined shift position based on the movement position of the shift body detected by the detection device. This thereby enables the shift body to be stopped appropriately at the predetermined shift position.

A shift device of a second aspect of the present invention is the shift device of the first aspect of the present invention, further comprising a connection mechanism that connects a side of the shift body and a side of the mover device, and that is configured to release a connection between the side of the shift body and the side of the mover device when an external force is applied to the shift body.

In the shift device of the second aspect of the present invention, the connection mechanism connects the side of the shift body and the side of the mover device, and the connection between the side of the shift body and the side of the mover device by the connection mechanism is configured to release when an external force is applied to the shift body. This enables external force applied to the shift body to be suppressed from being input to the side of the mover device.

A shift device of a third aspect of the present invention is the shift device of the second aspect of the present invention, further comprising a mover member that is provided further to a side of the mover device than a position at which the side of the shift body and the side of the mover device are connected by the connection mechanism, and that is moved so as to move the shift body, movement of the mover member being capable of being stopped by the stopper mechanism at a plurality of movement positions.

In the shift device of the third aspect of the present invention, the movement member is provided further to the side of the mover device than the position at which the side of the shift body and the side of the mover device are connected by the connection mechanism. The shift body is moved by movement of the mover member.

The stopper mechanism is capable of stopping movement of the mover member at plural movement positions of the mover member. Accordingly, the stopper mechanism is capable of stopping movement of the mover member and capable of stopping the shift body at the predetermined shift position even when the movement position of the mover member when the shift body is disposed at the predetermined shift position changes.

### BRIEF DESCRIPTION OF THE DRAWINGS

Exemplary embodiments of the present invention will be described in detail based on the following figures, wherein:

FIG. 1 is a perspective view illustrating a shift lever device according to an exemplary embodiment of the present invention, as viewed obliquely from the upper-left;

FIG. 2 is a perspective view illustrating the shift lever device according to the exemplary embodiment of the present invention, as viewed obliquely from the lower-left;

FIG. 3 is a perspective view illustrating relevant portions of the shift lever device according to the exemplary embodiment of the present invention, as viewed obliquely from the upper-left;

FIG. 4 is a cut-away perspective view illustrating relevant portions of the shift lever device according to the exemplary embodiment of the present invention, as viewed obliquely from the upper-left;

FIG. 5 is a perspective view illustrating relevant portions of the shift lever device according to the exemplary embodiment of the present invention, as viewed obliquely from the upper-right;

FIG. 6 is a perspective view illustrating relevant portions of the shift lever device according to the exemplary embodiment of the present invention, as viewed obliquely from the upper-left;

FIG. 7 is a perspective view illustrating an index plate and the like in the shift lever device according to the exemplary embodiment of the present invention, as viewed obliquely from the upper-left; and

FIG. 8 is a perspective view illustrating a second worm wheel and the like in the shift lever device according to the exemplary embodiment of the present invention, as viewed obliquely from the upper-left.

### DETAILED DESCRIPTION

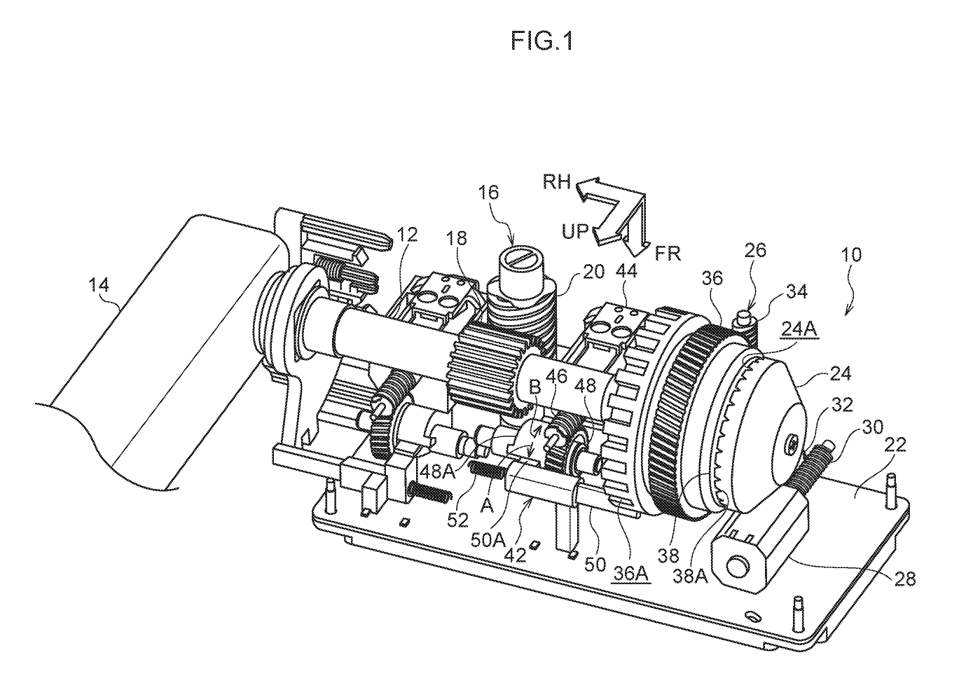

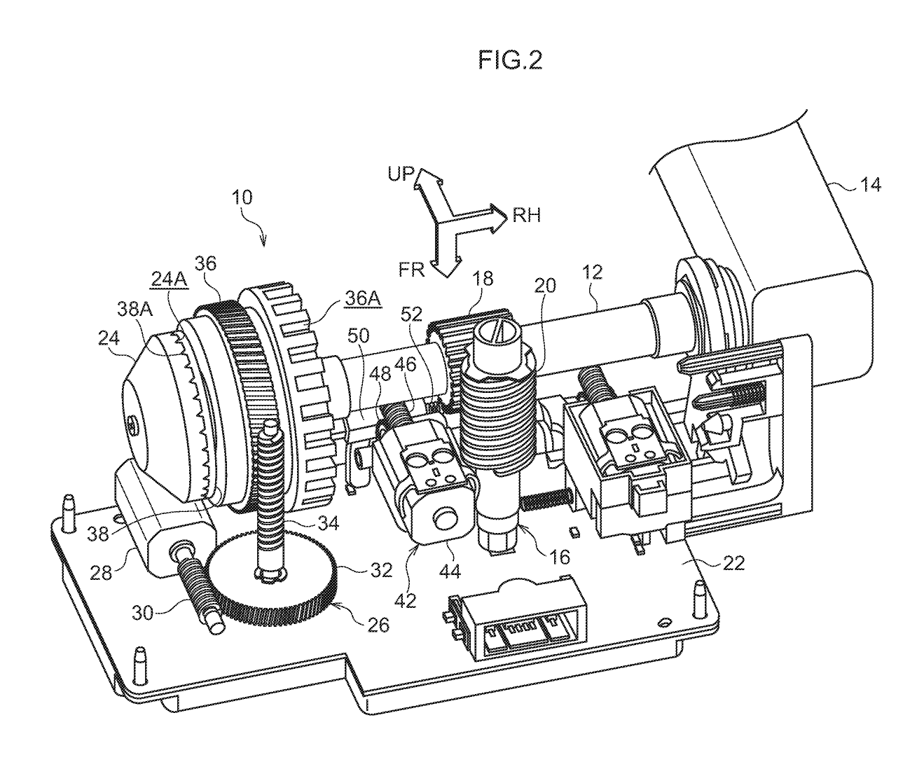

FIG. 1 illustrates a shift lever device 10, serving as a shift device according to an exemplary embodiment of the present invention, in a perspective view as viewed obliquely from the upper-left. FIG. 2 illustrates the shift lever device 10 in a perspective view as viewed obliquely from the lower-left. Note that in the drawings, the arrow FR indicates the front of the shift lever device 10, the arrow RH indicates the right of the shift lever device 10, and the arrow UP indicates the upper side of the shift lever device 10.

The shift lever device 10 according to the present exemplary embodiment is configured as what is referred to as a column-mounted type, and is installed to a steering column of a vehicle. The front, right, and upper sides of the shift lever device 10 face toward the lower-rear, upper-rear, and right side of the vehicle, respectively.

As illustrated in FIG. 1 and FIG. 2, a cylindrical column shaped rotation shaft 12, serving as a rotation member, is provided to the shift lever device 10. The rotation shaft 12 is supported at the vehicle body side so as to be capable of rotating, and is disposed such that its axial direction is parallel to the left-right direction.

A lower end (base end) of a substantially elongated rod shaped shift lever 14, serving as a shift body, is supported at a right end of the rotation shaft 12 so as to be capable of rotating as a unit with the rotation shaft 12. The shift lever 14 is capable of pivoting (moving) in the front-rear direction about the rotation shaft 12. An upper-side portion of the shift lever 14 extends out into the vehicle cabin so as to be capable of pivoting. The shift lever 14 is able to be pivot-operated in the front-rear direction in a state in which an occupant of the vehicle (particularly the driver) has gripped an upper-end portion (leading end portion) of the shift lever 14. The shift position of the shift lever 14 is thereby changed between, for example, a P position (a predetermined shift position), an R position, an N position, and a D position in this sequence on progression from the rear to the front.

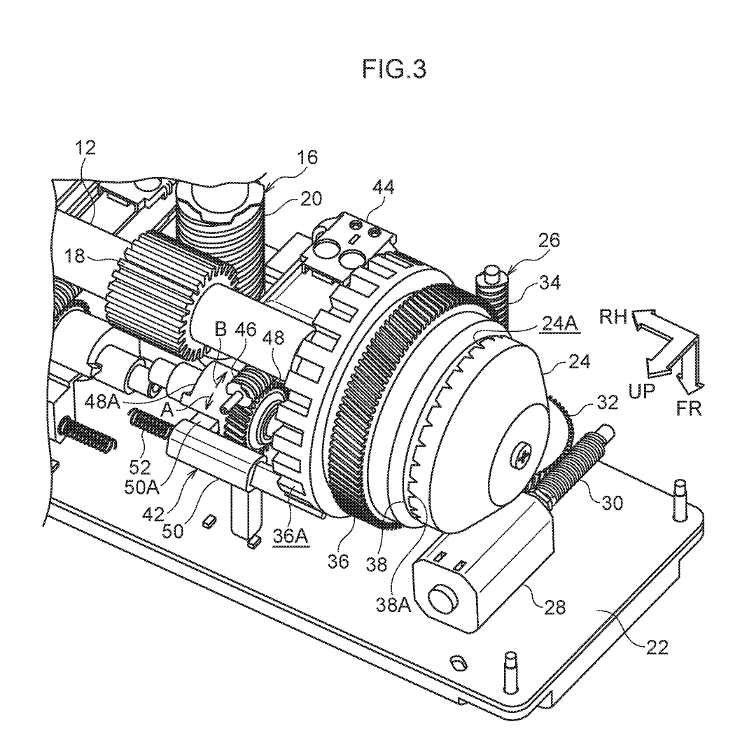

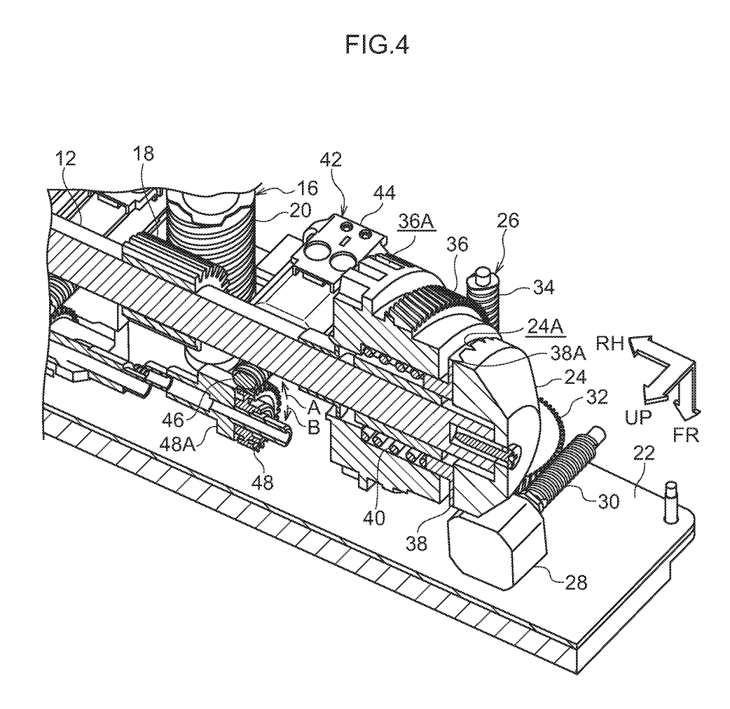

A detection device 16 (see FIG. 3 and FIG. 4) is provided close to the rotation shaft 12.

The detection device 16 is provided with a rotating gear 18 that serves as a detection section. The rotating gear 18 is coaxially fixed to a left-right direction intermediate portion of the rotation shaft 12. A detection gear 20, serving as a detection member, meshes with the lower side of the rotating gear 18. The axial direction of the detection gear 20 is disposed parallel to the front-rear direction. When the shift lever 14 is pivoted in the front-rear direction, the rotating gear 18 rotates as a unit together with the rotation shaft 12, thereby rotating the detection gear 20.

A substrate 22 that serves as a detection unit and a control unit is disposed in the vicinity of the front side of the detection gear 20. The substrate 22 is disposed perpendicular to the front-rear direction. The substrate 22 is able to detect the rotational position of the detection gear 20 (the rotational position of a magnet fixed to the front end of the detection gear 20). The substrate 22 detects the rotational position of the detection gear 20 and detects the rotational position of the rotation shaft 12 (the rotating gear 18) to detect the pivot position of the shift lever 14 in the front-rear direction and thereby detect the shift position of the shift lever 14.

A substantially circular disk shaped rotation plate 24, serving as a connected member configuring a connection mechanism, is coaxially fixed to a left end portion of the rotation shaft 12. The rotation plate 24 is capable of rotating as a unit together with the rotation shaft 12. Plural engagement recesses 24A with triangular cross-sections, serving as engaged portions, are formed in a right face of the rotation plate 24. The plural engagement recesses 24A respectively extend along radial directions of the rotation plate 24, and are disposed spaced apart at equal intervals around the circumferential direction of the rotation plate 24.

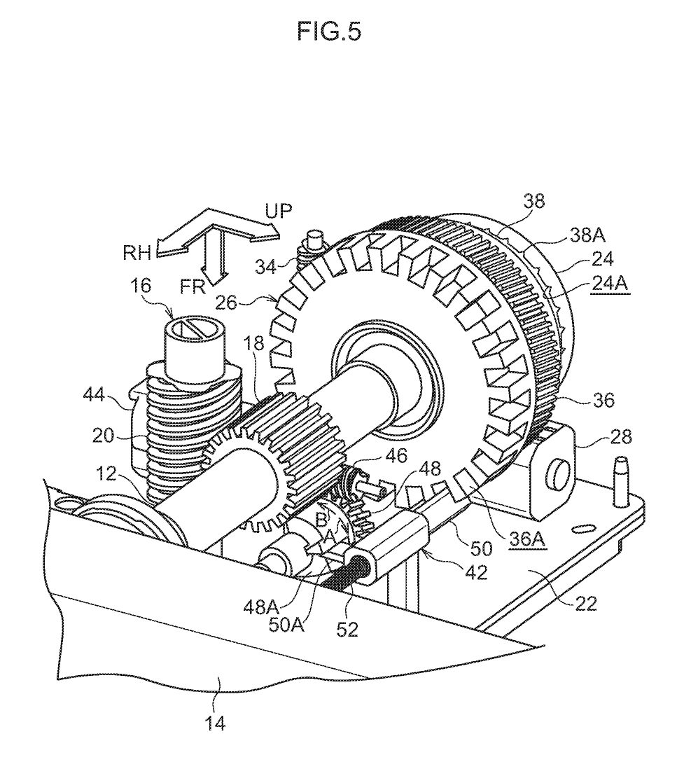

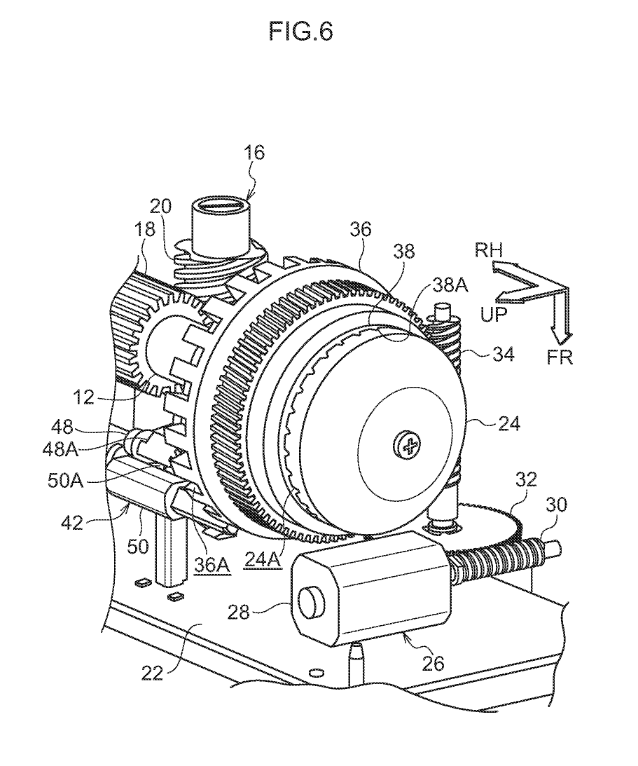

A drive device 26 that serves as a mover device (see FIG. 5 and FIG. 6) is provided close to the rotation shaft 12.

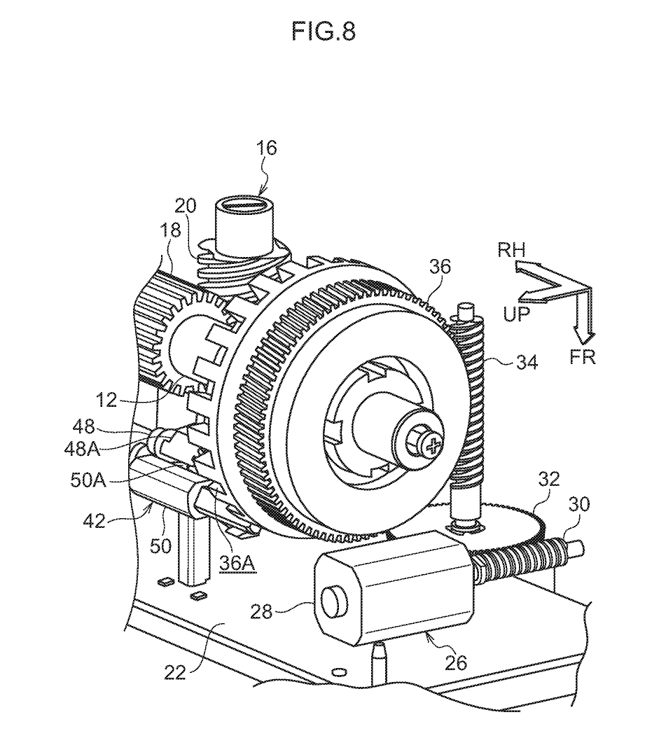

The drive device 26 is provided with a drive motor 28. The drive motor 28 is disposed at the lower side of the rotation plate 24. The drive motor 28 is electrically connected to the substrate 22, and the drive motor 28 is able to be driven under the control of the substrate 22. An output shaft of the drive motor 28 is disposed parallel to the up-down direction, and a first worm 30 is coaxially fixed to the output shaft of the drive motor 28. The first worm 30 meshes with a first worm wheel 32. The axial direction of the first worm wheel 32 is disposed parallel to the front-rear direction. A second worm 34 is coaxially coupled to the rear side of the first worm wheel 32. The second worm 34 is able to rotate as a unit together with the first worm wheel 32. A second worm wheel 36 (see FIG. 8), serving as a mover member, meshes with the second worm 34. The second worm wheel 36 is coaxially supported by the rotation shaft 12 at the right side of the rotation plate 24, and is restricted from moving in the left-right direction (axial direction) with respect to the rotation shaft 12. The second worm wheel 36 is supported by the rotation shaft 12 so as to be capable of rotating, and rotation of the second worm wheel 36 is restricted by the first worm 30, the first worm wheel 32, and the second worm 34. The first worm 30, the first worm wheel 32, and the second worm 34 rotate when the drive motor 28 is driven, thereby rotating the second worm wheel 36.

Plural cuboidal stopper notches 36A, serving as stopper portions, are provided at the outer circumference of a right end portion of the second worm wheel 36. The stopper notches 36A are open toward the radial direction outside and right side of the second worm wheel 36. The plural stopper notches 36A are disposed spaced apart at equal intervals around the circumferential direction of the second worm wheel 36. The placement angle interval between stopper notches 36A around the circumferential direction of the second worm wheel 36 is the same as the placement angle interval between the engagement recesses 24A of the rotation plate 24 around the circumferential direction of the rotation plate 24.

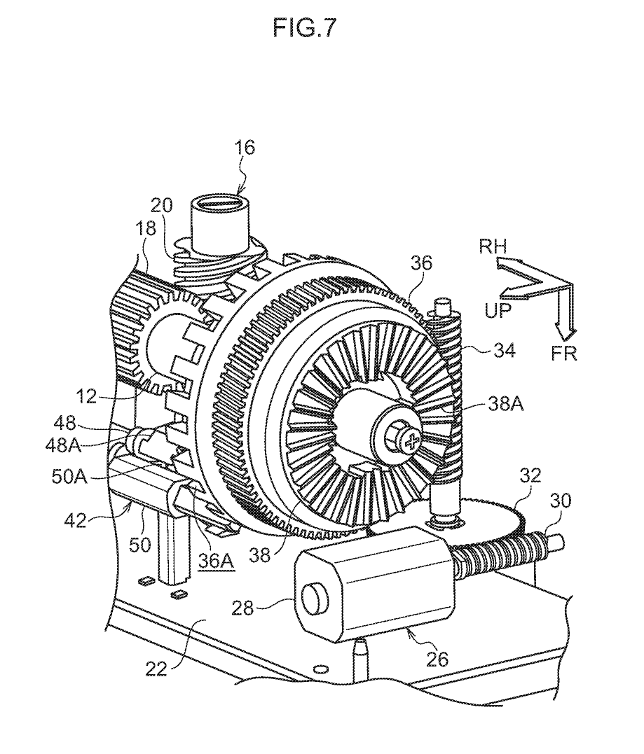

A substantially annular plate shaped index plate 38 (see FIG. 7), serving as a connection member configuring the connection mechanism, is coaxially provided at the left side of the second worm wheel 36 and right side of the rotation plate 24. The index plate 38 is capable of rotating as a unit together with the second worm wheel 36, and is able to move along the left-right direction (the axial direction) with respect to the second worm wheel 36. Plural engagement protrusions 38A with triangular cross-sections, serving as engaging portions, are formed in a left face of the index plate 38. The engagement protrusions 38A extend in radial directions of the index plate 38. The plural engagement protrusions 38A are disposed spaced apart at equal intervals around the circumferential direction of the index plate 38. The placement angle interval of the engagement protrusions 38A around the circumferential direction of the index plate 38 is the same as the placement angle interval of the engagement recesses 24A of the rotation plate 24 around the circumferential direction of the rotation plate 24.

A spring 40 (a compression coil spring, see FIG. 4), serving as a biasing member configuring the connection mechanism, spans between the second worm wheel 36 and the index plate 38 at the radial direction outside of the rotation shaft 12. The spring 40 biases the index plate 38 toward the left side. When the shift lever 14 is disposed at one of the shift positions, the engagement protrusions 38A of the index plate 38 interlock with (are inserted into, engage with) the engagement recesses 24A of the rotation plate 24 under the biasing force from the spring 40, thereby connecting the rotation plate 24 and the index plate 38 together. Rotation of the rotation plate 24 is thus restricted by biasing force from the spring 40, retaining the shift lever 14 at the shift position. When the shift lever 14 is pivot operated between shift positions, the rotation plate 24 is rotated, and after releasing the interlocking between the engagement protrusions 38A and the engagement recesses 24A against the biasing force of the spring 40 (after releasing the connection between the rotation plate 24 and the index plate 38), the engagement protrusions 38A interlock with the engagement recesses 24A by the biasing force of the spring 40, imparting the pivot operation of the shift lever 14 with an indexing sensation.

A stopper mechanism 42 (see FIG. 3 to FIG. 5) is provided close to the rotation shaft 12.

The stopper mechanism 42 is provided with a stopper motor 44. The stopper motor 44 is disposed on the right side of the second worm wheel 36 of the drive device 26. The stopper motor 44 is electrically connected to the substrate 22, and the stopper motor 44 can be driven under the control of the substrate 22. An output shaft of the stopper motor 44 is disposed parallel to the up-down direction, and a stopper worm 46 is coaxially fixed to the output shaft of the stopper motor 44. The stopper worm 46 meshes with a stopper worm wheel 48, and the axial direction of the stopper worm wheel 48 is disposed parallel to the left-right direction. Rotation of the stopper worm wheel 48 is restricted by the stopper worm 46, and driving the stopper motor 44 rotates the stopper worm 46, thereby enabling the stopper worm wheel 48 to rotate in either a stop direction (the arrow A direction in FIG. 5 and the like) or a release direction (the arrow B direction in FIG. 5 and the like). Moreover, the stopper worm wheel 48 is in a state rotated in the release direction (FIG. 5 and the like illustrate a state in which the stopper worm wheel 48 has been rotated in the stop direction). A cam face 48A, serving as a mover portion, is formed at a right face of the stopper worm wheel 48. The cam face 48A is inclined in a direction toward the left side on progression toward the release direction.

A substantially rectangular column shaped link 50, serving as a stopper member, is disposed at the upper side of the stopper worm wheel 48. The link 50 is disposed parallel to the left-right direction. The link 50 is capable of moving in the left-right direction, while up-down direction and front-rear direction movement of the link 50 are restricted. A rectangular plate shaped moving plate 50A is integrally provided at a right end portion of the link 50. The moving plate 50A projects out toward the lower side. A stopper spring 52 (compression coil spring) is provided at a right side of the link 50, and the stopper spring 52 biases the link 50 toward the left side. The moving plate 50A of the link 50 contacts the cam face 48A of the stopper worm wheel 48 from the right side under the biasing force of the stopper spring 52, and the link 50 is separated to the right side of the second worm wheel 36 of the drive device 26 (FIG. 5 and the like illustrate a state in which the link 50 has been moved toward the left side). When the stopper worm wheel 48 is rotated in the stop direction, the cam face 48A is rotated in the stop direction, and the contact position between the moving plate 50A and the cam face 48A is displaced toward the left side while the biasing force of the stopper spring 52 moves the link 50 toward the left side. Accordingly, the link 50 is capable of moving to a stop position, and a left end portion of the link 50 is capable of fitting together with the stopper notches 36A of the second worm wheel 36. Moreover, the left-right direction position of the link 50 (left-right direction position of a magnet fixed to the front side of the link 50) is capable of being detected by the substrate 22.

Next, explanation follows regarding operation of the present exemplary embodiment.

In the shift lever device 10 configured as described above, the shift lever 14 is pivot operated in the front-rear direction so as to be disposed at the P position, the R position, the N position, or the D position. Moreover, when the shift lever 14 is pivoted in the front-rear direction, in the detection device 16, the rotating gear 18 rotates as a unit together with the shift lever 14 and the rotation shaft 12, thereby rotating the detection gear 20. The substrate 22 accordingly detects the rotation position of the detection gear 20, thereby detecting the pivot position of the shift lever 14 in the front-rear direction.

When the shift lever 14 is disposed at one of the shift positions, in the drive device 26, the engagement protrusions 38A of the index plate 38 interlock with the engagement recesses 24A of the rotation plate 24 under the biasing force of the spring 40, such that the index plate 38 restricts rotation of the rotation plate 24, thereby restricting rotation of the rotation shaft 12 and retaining the shift lever 14 at the shift position. When the shift lever 14 is pivot operated between the shift positions, the rotation plate 24 is rotated, releasing the interlocking between the engagement protrusions 38A and the engagement recesses 24A against the biasing force of the spring 40, after which the engagement protrusions 38A interlock with the engagement recesses 24A again under the biasing force of the spring 40.

On a predetermined occasion (for example when the vehicle engine has been stopped) in a state in which the shift lever 14 is disposed at a position other than the P position, the drive motor 28 of the drive device 26 is driven under the control of the substrate 22 so as to rotate the first worm 30, the first worm wheel 32, and the second worm 34. The second worm wheel 36, the index plate 38, the rotation plate 24, and the rotation shaft 12 accordingly rotate together as a unit, pivoting the shift lever 14 toward the P position side.

Note that when the detection device 16 has detected that the shift lever 14 is about to be pivoted to the P position, the stopper motor 44 of the stopper mechanism 42 is driven under the control of the substrate 22, thereby rotating the stopper worm 46, such that the stopper worm wheel 48 (including the cam face 48A) is rotated in the stop direction, and the link 50 is moved toward the left side under the biasing force of the stopper spring 52. Accordingly, when the shift lever 14 is pivoted to the P position, the left end portion of the link 50 is fitted into one of the stopper notches 36A of the second worm wheel 36 by the movement toward the stop position, such that the link 50 stops rotation of the second worm wheel 36, thereby stopping rotation of the index plate 38, the rotation plate 24, and the rotation shaft 12, and stopping the shift lever 14 at the P position. Accordingly, the shift lever 14 can be stopped appropriately at the P position, and pivoting of the shift lever 14 beyond the P position by the drive device 26 can be restricted.

Moreover, when the fact that the link 50 has moved to the stop position has been detected by the substrate 22, drive of the drive motor 28 is stopped under the control of the substrate 22. Accordingly, unlike cases in which drive of the drive motor 28 is stopped by the substrate 22 detecting an excessive current (locking current) flowing in the drive motor 28 due to the second worm wheel 36 being stopped, thereby restricting drive of the drive motor 28, excessive current flow in the drive motor 28 can be suppressed, enabling the load on the drive motor 28 to be reduced.

Moreover, when the shift lever 14 is pivoted by the drive device 26, in cases in which external force acts on the shift lever 14, the interlocking between the engagement protrusions 38A and the engagement recesses 24A is released against the biasing force of the spring 40, permitting rotation of the rotation plate 24, the rotation shaft 12, and the shift lever 14 with respect to the index plate 38. This thereby enables external force acting on the shift lever 14 to be suppressed from being input to the drive device 26, enabling damage to the drive device 26 to be suppressed.

Moreover, plural of the stopper notches 36A are provided around the rotation direction of the second worm wheel 36 of the drive device 26, and the left end portion of the link 50 can be fitted into the stopper notches 36A, enabling the link 50 to stop rotation of the second worm wheel 36, at plural rotation positions of the second worm wheel 36. Accordingly, the left end portion of the link 50 can be fitted into the stopper notches 36A even in cases in which the rotation position of the second worm wheel 36 when the shift lever 14 is disposed at the P position changes due to the second worm wheel 36 being rotated by the drive device 26 in order to pivot the shift lever 14. This thereby enables the link 50 to stop rotation of the second worm wheel 36, and enables the shift lever 14 to be stopped at the P position.

Moreover, the stopper mechanism 42 stops rotation of the second worm wheel 36 of the drive device 26. Accordingly, unlike cases in which the stopper mechanism 42 stops rotation of a component (the shift lever 14, the rotation shaft 12, the rotation plate 24, or the like) further to the shift lever 14 side than the drive device 26, when the stopper mechanism 42 has stopped the shift lever 14 at the P position, a situation in which the interlocking between the engagement protrusions 38A and the engagement recesses 24A is released against the biasing force of the spring 40 so as to permit actuation of the drive device 26 can be restricted.

Note that in the present exemplary embodiment, when the fact that the link 50 has been moved to the stop position has been detected by the substrate 22, drive of the drive motor 28 is stopped under the control of the substrate 22. However, configuration may be made in which drive of the drive motor 28 is stopped under the control of the substrate 22 when the substrate 22 has detected excessive current flowing in the drive motor 28 as a result of the second worm wheel 36 being stopped so as to restrict drive of the drive motor 28.

Moreover, in the present exemplary embodiment, the stopper mechanism 42 stops rotation of the second worm wheel 36 of the drive device 26. However, configuration may be made in which the stopper mechanism 42 stops rotation of a component of the drive device 26 other than the second worm wheel 36, or stops a component further to the shift lever 14 side than the drive device 26.

Moreover, in the present exemplary embodiment, the drive device 26 pivots the shift lever 14 to the P position. However, configuration may be made in which the drive device 26 pivots the shift lever 14 to a predetermined shift position other than the P position (for example the N position).

Moreover, in the present exemplary embodiment, the shift lever 14 (shift body) is pivoted. However, the shift body may be rotated about an axis, or may slide.

Moreover, in the present exemplary embodiment, the shift lever device 10 (shift device) is installed to the steering column. However, the shift device may be installed to a floor, an instrument panel, or a console in the vehicle cabin.

What is claimed is:

1. A shift device comprising:
a shift body that is moved to change a shift position;
a mover device that moves the shift body to a predetermined shift position;
a detection device that detects a movement position of the shift body; and
a stopper mechanism that stops the shift body at the predetermined shift position based on the movement position of the shift body detected by the detection device when the mover device has moved the shift body.

2. The shift device of claim 1, further comprising a connection mechanism that connects a side of the shift body and a side of the mover device, and that is configured to release a connection between the side of the shift body and the side of the mover device when an external force is applied to the shift body.

3. The shift device of claim 2, further comprising a mover member that is provided further to a side of the mover device than a position at which the side of the shift body and the side of the mover device are connected by the connection mechanism, and that is moved so as to move the shift body, movement of the mover member being capable of being stopped by the stopper mechanism at a plurality of movement positions.
